(19) United States
(12) Patent Application Publication
(10) Pub. No.: US 2023/0395772 A1
(43) Pub. Date: Dec. 7, 2023

(54) METHOD OF PRODUCING SLURRY COMPOSITION, AND METHOD OF PRODUCING ALL-SOLID-STATE BATTERY

(71) Applicants: TOYOTA JIDOSHA KABUSHIKI KAISHA, Toyota-shi (JP); Panasonic Holdings Corporation, Osaka (JP)

(72) Inventors: Yasutaka TSUTSUI, Osaka-shi (JP); Takaaki TAMURA, Mishima-gun (JP)

(73) Assignees: TOYOTA JIDOSHA KABUSHIKI KAISHA, Toyota-shi (JP); Panasonic Holdings Corporation, Osaka (JP)

(21) Appl. No.: 18/325,350

(22) Filed: May 30, 2023

(30) Foreign Application Priority Data
Jun. 7, 2022 (JP) 2022-092107

(51) Int. Cl. H01M 4/04

(52) U.S. Cl. CPC H01M 4/0404; H01M 4/0409; H01M 4/0435

(57) ABSTRACT

A method of producing a slurry composition includes the following (a) to (c): (a) forming a binder solution by mixing a binder with a solvent; (b) filtering the binder solution to form a filtrate; and (c) producing a slurry composition by mixing the filtrate with a solid electrolyte.

This nonprovisional application is based on Japanese Patent Application No. 2022-092107 filed on Jun. 7, 2022, with the Japan Patent Office, the entire contents of which are hereby incorporated by reference.

### BACKGROUND

### Field

The present disclosure relates to a method of producing a slurry composition and a method of producing an all-solid-state battery.

### Description of the Background Art

Japanese Patent Laying-Open No. 2022-014285 discloses treating a resin solution with a filter cartridge to remove undissolved resin and contaminants.

### SUMMARY

Bulk-type all-solid-state batteries have been researched. The all-solid-state battery includes a power generation element. The power generation element may be formed by alternately stacking an electrode layer and a separator layer. Each of the layers in the power generation element may be formed by application of a slurry composition.

The slurry composition may be formed by mixing a binder solution and a powder component (such as an active material, a solid electrolyte, and/or the like). At the time of application of the slurry composition, dot-like irregularities may occur and impair productivity.

An object of the present disclosure is to reduce dot-like irregularities.

Hereinafter, the technical configuration and effects of the present disclosure will be described. It should be noted that the action mechanism according to the present specification includes presumption. The action mechanism does not limit the technical scope of the present disclosure.
1. A method of producing a slurry composition comprises the following (a) to (c):
(a) forming a binder solution by mixing a binder with a solvent;
(b) filtering the binder solution to form a filtrate; and
(c) producing a slurry composition by mixing the filtrate with a solid electrolyte.

According to a novel finding of the present disclosure, dot-like irregularities are caused by gel particles. The binder solution may be formed by mixing a binder with a solvent. The binder solution may include gel particles even when it appears to be uniform. The gel particles may include insoluble matter of the binder. The binder can precipitate as gel particles, even after it dissolves. When a binder solution that includes gel particles is used in a slurry composition, dot-like irregularities may occur.

In the production method according to “1.” above, the binder solution is filtered before forming the slurry composition. That is, the binder solution (filtrate) may be separated from gel particles (residue). When the filtrate (the binder solution after filtration) is used in the slurry composition, dot-like irregularities may be reduced.

The binder may include styrene-butadiene rubber, for example.

The solvent may include tetralin, for example.

The slurry composition may be for an electrode layer, or may be for a separator layer (a solid electrolyte layer).
2. In the method of producing a slurry composition according to “1.” above, (b) may include passing the binder solution through a filter material. The filter material may have an aperture of 20 m or less, for example.
3. In the method of producing a slurry composition according to “2.” above, the filter material may have an aperture of 2 m or less, for example.
4. In the method of producing a slurry composition according to any one of “1.” to “3.” above, a residue from the filtering in (b) may include gel particles.
5. In the method of producing a slurry composition according to any one of “1.” to “4.” above, (c) may include producing a slurry composition by mixing an active material, the filtrate, and the solid electrolyte.

The slurry composition that includes the active material may be applied to form an electrode layer.
6. A method of producing an all-solid-state battery comprises the following (d) to (f):
(d) forming a coating layer by applying, to a surface of a base material, the slurry composition produced by the method of producing a slurry composition according to any one of “1.” to “5.” above;
(e) forming a power generation element including the coating layer; and
(f) producing an all-solid-state battery including the power generation element.

In the following, an embodiment of the present disclosure (which may also be simply called “the present embodiment” hereinafter) and an example of the present disclosure (which may also be simply called “the present example” hereinafter) will be described. It should be noted that neither the present embodiment nor the present example limits the technical scope of the present disclosure.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic flowchart for a production method according to the present embodiment.

FIG. 2 is a conceptual view illustrating a power generation element according to the present embodiment.

### DESCRIPTION OF THE PREFERRED EMBODIMENTS

### Terms, Definitions Thereof, Etc.

Expressions such as “comprise”, “include”, and “have”, and other similar expressions (such as “be composed of”, for example) are open-ended expressions. In an open-ended expression, in addition to an essential component, an additional component may or may not be further included. The expression “consist of” is a closed-end expression. However, even when a closed-end expression is used, impurities present under ordinary circumstances as well as an additional element irrelevant to the technique according to the present disclosure are not excluded. The expression “consist essentially of” is a semiclosed-end expression. A semiclosed-end expression tolerates addition of an element that does not substantially affect the fundamental, novel features of the technique according to the present disclosure.

Expressions such as “may” and “can” are not intended to mean “must” (obligation) but rather mean “there is a possibility” (tolerance).

As for a plurality of steps, operations, processes, and the like that are included in various methods, the order for implementing those things is not limited to the described order, unless otherwise specified. For example, a plurality of steps may proceed simultaneously. For example, a plurality of steps may be implemented in reverse order.

A singular form also includes its plural meaning, unless otherwise specified. For example, “a particle” may mean not only “one particle” but also “a group of particles (powder, particles)”.

A numerical range such as “from m to n %” includes both the upper limit and the lower limit. That is, “from m to n %” means a numerical range of “not less than m % and not more than n %”. Moreover, “not less than m % and not more than n %” includes “more than m % and less than n %”. Further, any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean±5%, ±3%, ±1%, and/or the like, for example. Each numerical value may be an approximate value that can vary depending on the implementation configuration of the technique according to the present disclosure. Each numerical value may be expressed in significant figures. Each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error and/or the like occurring due to, for example, an identification limit of the measurement apparatus.

When a compound is represented by a stoichiometric composition formula (such as “LiCoO₂”, for example), this stoichiometric composition formula is merely a typical example of the compound. The compound may have a non-stoichiometric composition. For example, when lithium cobalt oxide is represented as “LiCoO₂”, the composition ratio of lithium cobalt oxide is not limited to “Li/Co/O=1/1/2” but Li, Co, and O may be included in any composition ratio, unless otherwise specified. Further, doping with a trace element and/or substitution may also be tolerated.

“D50” refers to a particle size in volume-based particle size distribution at which cumulative frequency of particle sizes accumulated from the small size side reaches 50%.

“Solid fraction” refers to the sum of the mass fractions of all the components other than solvent.

“Electrode” collectively refers to a positive electrode and a negative electrode. For example, an electrode layer collectively refers to a positive electrode layer and a negative electrode layer. An electrode layer may be a positive electrode layer, or may be a negative electrode layer.

“Hollow particle” refers to a particle in which, in a cross-sectional image (such as an electron micrograph, for example) of the particle, the area of the central cavity occupies at least 30% of the entire cross-sectional area of the particle. “Solid particle” refers to a particle in which, in a cross-sectional image of the particle, the area of the central cavity occupies less than 30% of the entire cross-sectional area of the particle.

<Production Method>

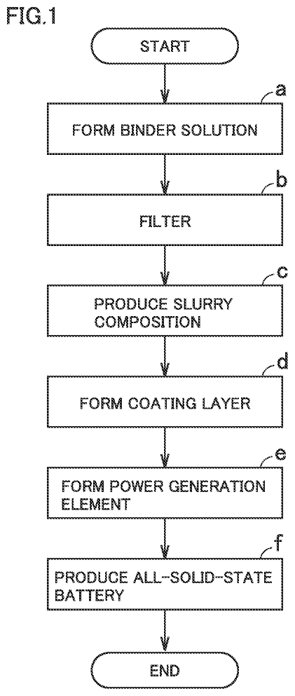

FIG. 1 is a schematic flowchart for a production method according to the present embodiment. Hereinafter, “the production method according to the present embodiment” may also be simply called “the present production method”. The present production method includes “a method of producing a slurry composition”, “a method of producing an electrode layer”, “a method of producing a separator layer”, and “a method of producing an all-solid-state battery”.

The method of producing a slurry composition includes “(a) forming a binder solution”, “(b) filtering”, and “(c) producing a slurry composition”.

The method of producing an electrode layer or the method of producing a separator layer includes “(d) forming a coating layer”, in addition to (a) to (c).

The method of producing an all-solid-state battery includes “(e) forming a power generation element” and “(f) producing an all-solid-state battery”, in addition to (a) to (d).

<<(a) Forming Binder Solution>>

The present production method includes forming a binder solution by mixing a binder with a solvent. In the present production method, any mixing apparatus may be used. As long as the binder can dissolve in the solvent, mixing conditions are not particularly limited. The mixing temperature may be from 10 to 40° C., for example.

The mixing duration may be from 8 to 24 hours, for example.

(Binder)

The binder is capable of binding solid materials to each other in an electrode layer or in a separator layer. The binder may include any component. The binder may include, for example, at least one selected from the group consisting of a rubber-based binder and a fluorine-based binder. The rubber-based binder may include, for example, at least one selected from the group consisting of butadiene rubber (BR), hydrogenated butadiene rubber, styrene-butadiene rubber (SBR), hydrogenated styrene-butadiene rubber, nitrile-butadiene rubber (NBR), hydrogenated nitrile-butadiene rubber, and ethylene-propylene rubber (EPM). The fluorine-based binder may include, for example, at least one selected from the group consisting of polyvinylidene difluoride (PVDF), vinylidene difluoride-hexafluoropropylene copolymer (PVDF-HFP), and polytetrafluoroethylene (PTFE). The binder may include polymer blends, polymer alloys, copolymers, and the like of the materials mentioned above. A binder that includes an SBR-derived component is also called “an SBR-based binder”. For example, the SBR-based binder may include an SBR-derived component in a percentage of 10% or more, or may include an SBR-derived component in a percentage of 30% or more, or may include an SBR-derived component in a percentage of 50% or more, or may include an SBR-derived component in a percentage of 70% or more, or may include an SBR-derived component in a percentage of 90% or more, in mass fraction. The SBR-based binder may consist of SBR.

The binder may include a thermoplastic resin. For example, when a power generation element that includes a thermoplastic resin is hot-pressed, the thermoplastic resin may become liquid. During the pressing, the thermoplastic resin may flow and move, and thereby the power generation element may become dense. When the power generation element is dense, battery properties (such as input-output properties, for example) is expected to be enhanced. The thermoplastic resin may include SBR and/or the like, for example. SBR may have a softening point that is preferable for hot pressing.

For example, the concentration of the binder in the binder solution may be from 1 to 20% or may be from 5 to 15% in mass fraction.

(Solvent)

As long as it is capable of dissolving the binder, the solvent may include any component. The solvent may include, for example, at least one selected from the group consisting of aromatic hydrocarbon, ester, alcohol, ketone, and lactam. The solvent may include, for example, at least one selected from the group consisting of tetralin, butyl butyrate, and N-methyl-2-pyrrolidone (NMP).

It is expected that butyl butyrate is less likely to degrade the sulfide-based solid electrolyte, as compared to NMP or the like, for example. It is expected that tetralin is less likely to degrade the sulfide-based solid electrolyte, as compared to butyl butyrate, NMP, or the like, for example.

<<(b) Filtering>>

The present production method includes filtering the binder solution to form a filtrate. The filtrate may also be called “a filtered binder solution”. The residue may include gel particles. That is, by filtration, at least some gel particles may be separated from the binder solution. The binder solution may include gel particles even when it appears to be uniform. Reducing gel particles is expected to reduce dot-like irregularities.

For example, the filtrate may be formed by passing the binder solution through a filter material. The filter material may include a screen filter, a depth filter, and/or the like, for example. The depth filter may have a pleated structure, for example. The filter material may have an aperture of 20 m or less, or may have an aperture of 2 m or less, for example. The filter material may have an aperture of 0.2 m or more, or may have an aperture of 1 m or more, for example. The filter material may have an aperture from 2 to 20 m, for example.

The smaller the aperture is, the more reduced the dot-like irregularities are expected to be. However, the smaller the aperture is, the more increased the filtration resistance may become. For example, pressure may be applied to the binder solution with the use of a pump and/or the like to pressure-transfer the binder solution.

<<(c) Producing Slurry Composition>>

The present production method includes producing a slurry composition by mixing the filtrate (the filtered binder solution) with a solid electrolyte. In the present production method, any mixing apparatus may be used. For example, an ultrasonic homogenizer and/or the like may be used.

The slurry composition may be for a separator layer. A slurry composition for a separator layer may be formed by mixing the filtrate with a solid electrolyte. A solvent may be added to the slurry composition for adjusting the solid fraction of the slurry composition. That is, the slurry composition may be produced by mixing the filtrate, a solid electrolyte, and a solvent. The additional solvent may be of the same type as, or may be of a different type from, the solvent in the binder solution. The solid fraction of the slurry composition may be from 30 to 50%, or may be from 35 to 45%, for example.

The slurry composition may be for an electrode layer. A slurry composition for an electrode layer may be formed by mixing an active material, the filtrate, and a solid electrolyte. A binder and a solvent may further be added. For example, the slurry composition for an electrode layer may be formed by mixing an active material, the filtrate, a solid electrolyte, a conductive material, the binder, and the solvent. These materials may be mixed all at once, or may be mixed in steps during the mixing process.

The additional solvent may be of the same type as, or may be of a different type from, the solvent in the binder solution. The solid fraction of the slurry composition may be from 30 to 50%, or may be from 35 to 45%, for example. The additional binder may be of the same type as, or may be of a different type from, the binder in the binder solution. The final amount of the binder to be used may be, for example, from 0.1 to 10 parts by mass relative to 100 parts by mass of the active material.

The slurry composition may further include a dispersant, a stabilizer, and/or the like, for example. The dispersant may include aminoamide, ammonium salt, carboxylic acid ester, and/or the like, for example.

(Active Material)

The active material may be in powder form. The active material may have a D50 from 1 to 30 m, for example. The active material may include hollow particles, for example. The active material may include solid particles, for example.

The active material may include a positive electrode active material. That is, the slurry composition may be for a positive electrode layer. The positive electrode active material may include, for example, at least one selected from the group consisting of LiCoO₂, LiNiO₂, LiMnO₂, LiMn₂O₄, Li(NiCoMn)O₂, Li(NiCoAl)O₂, Li(NiCoMnAl)O₂, and LiFePO₄. “(NiCoMn)” in “Li(NiCoMn)O₂”, for example, means that the constituents within the parentheses are collectively regarded as a single unit in the entire composition ratio. As long as (NiCoMn) is collectively regarded as a single unit in the entire composition ratio, the amounts of individual constituents are not particularly limited. Li(NiCoMn)O₂ may include, for example, at least one selected from the group consisting of LiNi_{1/3}Co_{1/3}Mn_{1/3}O₂, LiNi_{0.4}Co_{0.3}Mn_{0.3}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.05}Mn_{0.05}O₂. Li(NiCoAl)O₂ may include LiNi_{0.8}Co_{0.15}Al_{0.05}O₂ and/or the like, for example.

The positive electrode active material may be represented by, for example, the following formula (α):

Li_{1-y}NiₓMe₁₋ₓO₂ (α)

0.5≤x≤1

−0.5≤y≤0.5

Me includes, for example, at least one selected from the group consisting of Co, Mn, and Al. x may be 0.6 or more, or may be 0.7 or more, or may be 0.8 or more, or may be 0.9 or more, for example.

To the surface of the positive electrode active material, an elementary substance, an oxide, a carbide, a halide, and/or the like of a metal may be adhered. For example, an oxide of Zr, W, and/or the like may be adhered. The adherent may be distributed on the surface of the positive electrode active material in the shape of islands, for example.

For example, the positive electrode active material may be covered with an oxide layer. The oxide layer is also called a buffer layer. The oxide layer may inhibit direct contact between the positive electrode active material and a sulfide-based solid electrolyte. The oxide layer may have a thickness from 5 to 50 nm, for example. The oxide layer may include Li, Nb, Ti, P, O, F, and/or the like, for example.

The active material may include a negative electrode active material. That is, the slurry composition may be for a negative electrode layer. The negative electrode active material may include any component. The negative electrode active material may include, for example, at least one selected from the group consisting of natural graphite, artificial graphite, soft carbon, hard carbon, Si, SiOₓ (0<x<2; which may be doped with Mg and/or the like, for example), Si-based alloy, Sn, SnOₓ (0<x<2), Li, Li-based alloy, and Li₄Ti₅O₁₂. An alloy-based active material (such as Si, for example) may be supported by a carbon-based active material (such as graphite, for example) to form a composite material.

(Solid Electrolyte)

The solid electrolyte may form an ion conduction path inside the electrode layer and the separator layer. The solid electrolyte may be in powder form. The solid electrolyte may have a D50 from 0.1 to 5 m, for example. The amount of the solid electrolyte to be used may be, for example, from 1 to 200 parts by volume relative to 100 parts by volume of the active material. The solid electrolyte may include, for example, at least one selected from the group consisting of a sulfide-based solid electrolyte, an oxide-based solid electrolyte, and a hydride-based solid electrolyte.

The sulfide-based solid electrolyte includes S. The sulfide-based solid electrolyte may include Li, P, and S, for example. The sulfide-based solid electrolyte may further include O, Ge, Si, and/or the like, for example. The sulfide-based solid electrolyte may further include a halogen and/or the like, for example. The sulfide-based solid electrolyte may further include I, Br, and/or the like, for example. The sulfide-based solid electrolyte may be glass ceramic, or may be argyrodite, for example. The sulfide-based solid electrolyte may include, for example, at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—GeS₂—P₂S₅, Li₂S—P₂S₅, and Li₃PS₄.

For example, “LiI—LiBr—Li₃PS₄” refers to a sulfide-based solid electrolyte that is produced by mixing LiI, LiBr, and Li₃PS₄ at any molar ratio. For example, the sulfide-based solid electrolyte may be produced by a mechanochemical method. “Li₂S—P₂S₅” includes Li₃PS₄. Li₃PS₄ may be produced by mixing Li₂S and P₂S₅ at “Li₂S/P₂S5=75/25 (molar ratio)”, for example.

(Conductive Material)

The conductive material may form an electron conduction path inside the electrode layer. The amount of the conductive material to be used may be, for example, from 0.1 to 10 parts by mass relative to 100 parts by mass of the active material. The conductive material may include any component. The conductive material may include, for example, at least one selected from the group consisting of carbon black (CB), vapor grown carbon fiber (VGCF), carbon nanotube (CNT), and graphene flake (GF). CB may include, for example, at least one selected from the group consisting of acetylene black (AB), Ketjenblack (registered trademark), furnace black, channel black, and thermal black.

<<(d) Forming Coating Layer>>

The present production method may include forming a coating layer by applying the slurry composition to a surface of a base material. In the present production method, any coating apparatus may be used. For example, a die coater, a roll coater, and/or the like may be used.

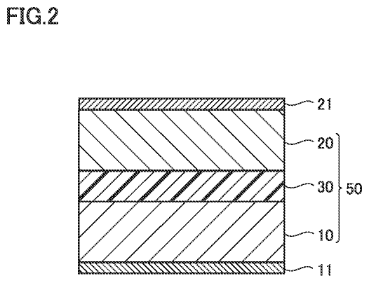

FIG. 2 is a conceptual view illustrating a power generation element according to the present embodiment. A base material 11 may be electrically conductive. Base material 11 may function as a current collector. Base material 11 may be in sheet form, or may be in mesh form, for example. Base material 11 may have a thickness from 5 to 50 m, for example. Base material 11 may include a metal foil, a metal mesh, a porous metal body, and/or the like, for example. Base material 11 may include, for example, at least one selected from the group consisting of Al, Cu, Ni, Cr, Ti, and Fe. Base material 11 may include Al foil, Al alloy foil, Ni foil, Cu foil, Cu alloy foil, Ti foil, SUS foil, and/or the like, for example. The surface of the metal foil may be covered with a carbon layer. For example, the carbon layer may include a conductive carbon material (such as CB, for example).

For example, the coating layer may be an electrode layer. For example, a slurry composition for an electrode layer may be applied to the surface of base material 11. The slurry composition may be dried to form a first electrode layer 10. In the present production method, any drying apparatus may be used. For example, a hot plate, a hot-air dryer, an infrared dryer, and/or the like may be used.

After first electrode layer 10 is dried, first electrode layer 10 may be pressed. For example, hot-pressing may be carried out, or cold-pressing may be carried out. For example, hot-pressing at 50 to 150° C. may be carried out. In the present production method, any pressing apparatus may be used. For example, a roll press and/or the like may be used. First electrode layer 10 after pressing may have a thickness from 10 to 200 m, for example.

The coating layer may be a separator layer, for example. For example, a slurry composition for a separator layer may be applied to the surface of first electrode layer 10 to form a separator layer 30. After separator layer 30 is dried, separator layer 30 may be pressed.

For example, separator layer 30 may be formed by applying the slurry composition for a separator layer to the surface of a temporary support (such as a metal foil, for example). After separator layer 30 is formed, separator layer 30 may be transferred onto the surface of first electrode layer 10.

<<(e) Forming Power Generation Element>>

The present production method includes forming a power generation element including the coating layer. For example, a power generation element 50 may be formed by forming a second electrode layer 20 on the surface of separator layer 30. Second electrode layer 20 may also be formed by application of a slurry composition. Second electrode layer 20 has a polarity that is different from the polarity of first electrode layer 10. For example, when first electrode layer 10 is a negative electrode layer, second electrode layer 20 is a positive electrode layer. For example, when first electrode layer 10 is a positive electrode layer, second electrode layer 20 is a negative electrode layer. Separator layer 30 is interposed between first electrode layer 10 and second electrode layer 20. Separator layer 30 may separate first electrode layer 10 from second electrode layer 20.

To the surface of second electrode layer 20, a current collector 21 may be connected. For example, current collector 21 may be affixed to the surface of second electrode layer 20 with an adhesive and/or the like. Current collector 21 may have the same structure as that of base material 11 described above.

Power generation element 50 may include a single first electrode layer 10, a single separator layer 30, and a single second electrode layer 20. Power generation element 50 may include a plurality of first electrode layers 10, a plurality of separator layers 30, and a plurality of second electrode layers 20. For example, power generation element 50 may be formed by alternately stacking the electrode layer and the separator layer. The number of coating layers included in power generation element 50 is not particularly limited. For example, power generation element 50 may include 3 to 100 coating layers.

Power generation element 50 may be pressed. For example, power generation element 50 may be hot-pressed.

<<(f) Producing All-Solid-State Battery>>

The present production method includes producing an all-solid-state battery that includes power generation element 50. For example, to power generation element 50, a lead tab, an external terminal, and/or the like may be connected. Power generation element 50 may be placed inside an exterior package (not illustrated). The exterior package may be hermetically sealed. The exterior package may have any configuration. The exterior package may be a pouch made of metal foil laminated film, and/or the like, for example. The exterior package may be a metal case and/or the like, for example. The exterior package may include Al and/or the like, for example. The exterior package may accommodate a single power generation element 50 alone, or may accommodate a plurality of power generation elements 50. The plurality of power generation elements 50 may form a series circuit, or may form a parallel circuit.

### EXAMPLES

### Production Example 1

<<(a) Forming Binder Solution>>

The below materials were prepared.

Binder: SBR-based binder (density, 0.9 g/cm³)

Solvent: tetralin

The binder and the solvent were weighted. The binder and the solvent were stirred within a glass vessel, and thereby the binder was dissolved in the solvent. That is, a binder solution was formed. The stirring duration was 16 hours. The mass fraction of the binder in the binder solution was 10%.

<<(b) Filtering>>

A filter cartridge (product number, SHP 200XS) manufactured by ROKI TECHNO was prepared. The filter cartridge includes a depth filter (a filter material) having a pleated structure. The aperture of the filter material was 20 km.

The binder solution was pressurized with a pump and passed through the filter cartridge, and thereby a filtrate was formed.

<<(c) Producing Slurry Composition>>

The below materials were prepared.
Active material: Li₄Ti₅O₁₂ (density, 3.5 g/cm³)
Conductive material: VGCF (density, 2 g/cm³)
Binder: SBR-based binder (density, 0.9 g/cm³)
Solid electrolyte: sulfide-based solid electrolyte (density, 2 g/cm³)
Dispersant: alkylolaminoamide-type
Solvent: tetralin

With the use of an ultrasonic homogenizer (model UH-50) manufactured by SMT, 102 parts by mass of the active material, 34 parts by mass of the solid electrolyte, 0.5 parts by mass of the dispersant, 1.1 parts by mass of the conductive material, and 93 parts by mass of the solvent were mixed, and thereby a suspension was formed. To the resulting suspension, 8.8 parts by mass of the filtrate (obtained in the above manner) was added. The suspension was stirred with the use of the ultrasonic homogenizer until the suspension became uniform. Thus, a slurry composition was produced.

<<(d) Forming Coating Layer>>

As a base material, an Al foil was prepared. The surface of the Al foil had a carbon layer formed thereon. By a blade method, the slurry composition was applied to the surface of the base material. The coating film was dried at 110° C. for 30 minutes, and thereby a negative electrode layer was formed. With a roll press, the negative electrode layer was pressed. The pressing temperature was room temperature. The linear pressure was 0.3 t/cm.

Under the above-described conditions, a plurality of negative electrode layers were formed. On the surface of each negative electrode layer, dots with a maximum Feret diameter of 1 mm or more were counted by visual examination. The number of such dots was divided by the number of samples (the number of negative electrode layers) to determine the incidence rate of dot-like irregularities.

Further, when there was a dot with a maximum Feret diameter of 2 μm or more observed on the surface of the negative electrode layer, the negative electrode layer was rated as defective. The number of defective layers was divided by the number of samples to determine the defective rate (in percentage).

### Production Example 2

A slurry composition was produced and a negative electrode layer was formed in the same manner as in Production Example 1 except that the binder solution was filtered through a filter cartridge (product number, SHP 020XS) manufactured by ROKI TECHNO. The aperture of the filter material of Production Example 2 was 2 m.

### Production Example 3

A slurry composition was produced and a negative electrode layer was formed in the same manner as in Production Example 1 except that the binder solution was used without filtering.

TABLE 1

| | Production | Production | Production |
|---|---|---|---|
| | Example 3 | Example 1 | Example 2 |
| Aperture of filter material | No filtration | 20 μm | 2 μm |
| Incidence of dot-like | 25 dots | 2.5 dots | 0.15 dots |
| irregularities | | | |
| Defective rate | 100% | 20% | 0% |

<Results>

There was a tendency that filtering the binder solution reduced dot-like irregularities. There was a tendency that the smaller the aperture of the filter material was, the more reduced the dot-like irregularities were.

The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that certain configurations of the present embodiments and the present examples can be optionally combined.

What is claimed is:

1. A method of producing a slurry composition, comprising:
(a) forming a binder solution by mixing a binder with a solvent;
(b) filtering the binder solution to form a filtrate; and
(c) producing a slurry composition by mixing the filtrate with a solid electrolyte.

2. The method of producing a slurry composition according to claim 1, wherein
the (b) includes passing the binder solution through a filter material, and
the filter material has an aperture of 20 μm or less.

3. The method of producing a slurry composition according to claim 2, wherein the filter material has an aperture of 2 μm or less.

4. The method of producing a slurry composition according to claim 1, wherein a residue from the filtering in the (b) includes gel particles.

5. The method of producing a slurry composition according to claim 1, wherein the (c) includes producing a slurry composition by mixing an active material, the filtrate, and the solid electrolyte.

6. A method of producing an all-solid-state battery, comprising:
(d) forming a coating layer by applying, to a surface of a base material, the slurry composition produced by the method of producing a slurry composition according to claim 1;
(e) forming a power generation element including the coating layer; and
(f) producing an all-solid-state battery including the power generation element.
